(19) United States
(12) Patent Application Publication
(10) Pub. No.: US 2006/0230270 A1
(43) Pub. Date: Oct. 12, 2006

(54) Method and apparatus for providing status information from a security and automation system to an emergency responder

(76) Inventor: Glen P. Goffin, Dublin, PA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/337,728

(22) Filed: Jan. 23, 2006

Related U.S. Application Data
(60) Provisional application No. 60/669,101, filed on Apr. 7, 2005.

(51) Int. Cl. H04L 9/00

(52) U.S. Cl. 713/173; 713/156; 713/175

(57) ABSTRACT

An access portal is provided for establishing communication between an environmental management system used on a premises and an authorized responder equipped with an external access device. In some cases a remote host server is provided for obtaining information from the environmental management system, which in turn can transmit the information to the external access device. The access portal includes a first electronic memory segment configured to store access information associated with at least one authorized responder and a second electronic memory segment configured to store information pertaining to the premises and/or at least one occupant residing in the premises. The access portal also includes a processor for identifying a responder as an authorized responder by comparing identifying information received from the responder through the external access device with the access information stored in the first electronic memory segment. A wireless transceiver is provided for (i) receiving the identifying information and requests from the responder and, (ii) in response to a request, transmitting the premises information stored in the second electronic memory segment and status information obtained from at least one sensor in the environmental management system to an authorized responder.

### STATEMENT OF RELATED APPLICATION

This application claims the benefit of U.S. Provisional Patent Application No. 60/669,101, filed Apr. 7, 2005, which is incorporated by reference in its entirety herein.

### FIELD OF THE INVENTION

The invention relates generally to security and automation systems, and more particularly to a security and automation system in which an emergency responder dispatched to the premises can obtain status information from the system and possibly control features and functionality thereof.

### BACKGROUND OF THE INVENTION

In residential and commercial environments there are often one or more environmental management systems providing a variety of functions. For instance, electronic security systems are relatively common in residential and commercial environments. Individuals and families, in particular, desire a security system that monitors a defined premises and/or environment, to prevent or deter theft, burglary and robbery. Monitoring functions that may be performed include the ability to track the location of assets and people within and around a premises. In addition, there is a desire to monitor and detect other hazardous or threatening conditions and, in response to detecting such a condition, generate a warning. These other potentially hazardous conditions or threats include, for example, fire hazards, carbon monoxide and power failure and electricity outages.

A conventional security system for use in a residence, office or the like, includes one or more keypads with displays and a central control panel, which in some cases is remotely located from the keypads and displays. A number of sensors for detecting various conditions are arranged in the premises. In legacy security systems, the sensors are most commonly connected to the control panel by wired means. The sensors may be of various types designed to detect a variety of conditions. More recently, wireless security systems have become available. In either case the sensors are generally relatively simple devices having two operational states represented by a contact that is either in an open or closed state.

In addition to security systems, home automation systems are another type of environmental management system that are becoming more readily available in residences. Home automation systems, or home management systems as they are sometimes called, enable control of lighting, heating and air conditioning, window shades or curtains, pool heaters and filtration systems, lawn sprinklers, ornamental fountains, audio/visual equipment, and other appliances. Home automation systems range from relatively simple systems that control one or a few functions in a home to more elaborate systems that control multiple, disparate features.

In general, a home automation or control system comprises one or more controlled devices, one or more controllers, and a communication link coupling a controller to a controlled device. The controllers may be directly programmable, in which case they include some form of user interface for setting switches, event timing, and the like. Alternatively, the controllers may be indirectly or remotely programmable, in which case a separate user interface may be implemented by a personal computer or the like. Systems may be programmed using either a simple command language or using a graphical user interface that requires a computer with a monitor.

Recently, some efforts have been made to provide integrated security and automation systems. In addition to the simplifications that arise from using a single platform, this combination of systems offers enhanced functionality and features that neither provide on their own. For instance, home automation systems may be integrated with a home security system so that when a fire alarm is raised, for example, internal and external lights will be turned on. An example of such a system is Home Automation Inc.'s Omni Automation and Security System, which includes a controller that can support both security and automation needs.

Currently, home security and automation systems offer limited services when an emergency event arises that triggers an alarm or other alert. Such security services are generally confined to sounding an alarm and/or dispatching the police or other security entity. However, depending on the type of event detected and its degree of severity, a resident or other occupant may want a more comprehensive and effective response. Likewise, to ensure their own safety, the responder that is dispatched will generally want and need to have as much information as possible before entering a premises in which an alarm has been triggered.

### BRIEF DESCRIPTION OF THE DRAWINGS

FIG. 1 shows an example of an environmental management system.

FIG. 2 shows the access portal of FIG. 1 in greater detail.

FIG. 3 shows an illustrative representation of an emergency responder database that may be located in the access portal.

FIG. 4 shows an example of the main status menu that an authorized responder may view on the external access device.

FIG. 5 shows a sub-menu that is available from the main status menu of FIG. 4.

FIG. 6 shows an example of the main control menu that an authorized responder may view on the external access device.

FIG. 7 shows a sub-menu that is available from the main control menu of FIG. 6.

FIG. 8 is a flowchart showing an example of how a responder establishes communication with an environmental management system after it has generated an alert.

### DETAILED DESCRIPTION

In general, environmental management systems may be used to provide security and automation to a home, office, or other type of commercial or residential building. In the residential context, these systems establish a home network that controls, coordinates, facilitates, and monitors user-designated activities within the home. The systems may also provide compatibility between external and internal networks, systems, and appliances. As used herein the term environmental management system encompasses security systems or automation systems as well as systems that provide both security and automation. As described in more detail below, when an alert is generated (either by the environmental management system or by an individual calling 911, etc.) which causes an emergency responder to be dispatched to the premises, the arrangement disclosed herein allows the emergency responder to quickly obtain information pertaining to the premises from the system even before entering the premises. In some cases this information is available directly from an access portal located on the premises itself. In other cases this information is maintained off-site by a remote hosting server. Various examples of both arrangements will be presented below, with an arrangement in which the access portal is located on-premises being presented first.

When an emergency responder arrives at a premises it is generally not clear precisely what triggered the alert received by the service provider or other entity. In some cases limited information may have been included with the initial alert such as whether the alert arises from activation of a security sensor or a fire sensor, the particular room or zone in which the activated sensor is located, and similar information. Despite this, there is often considerable historical and real-time information that is internally available to the environmental management system that is not communicated along with the alert and thus is not available to the emergency responder when he or she arrives at the premises. This is particularly true as such systems have come to include more sophisticated sensors as well as automation and control devices. For instance, video cameras employed in the system may capture an image of an intruder entering the premises. Similarly, if the intruder is still present when the emergency responder arrives, the video recordings may even indicate where in the premises the intruder is currently located, yet this information is rarely available to the emergency responder.

In addition to the inaccessibility to information acquired by the management system, the emergency responders are generally not able to avail themselves of the control and automation features that may be offered by the system. For instance, continuing with the example of an intruder, it would be helpful if the emergency responder arriving at the premises could control the video cameras so that he or she could obtain as much information about, say its layout, the path taken by the intruder through the premises, obstacles that may impair the responder's ability to safely and adequately take any action that the situation demands, and the like. In addition, the emergency responder might want to take precautionary measures such as turning on or off various lights or cutting the main power to the premises. Of course, the emergency responder may wish to take many of these same measures, as well as others, if the alert arises from some cause other than an intruder, such as a fire, gas leak, or the failure of a system or device. For instance, in the case of fire, the responder may want to know the current temperature in the various rooms of the premises to determine where he or she may safely enter.

In one example, the environmental management system disclosed herein addresses the aforementioned needs by including an access portal that allows an emergency responder to obtain real-time and historical information available to the monitoring system and to manage any systems or devices that are under the control of the system. The responder is equipped with an external access device to acquire the information from the portal in a wireless manner. The external access device may be any appropriate device that can establish communication with the environmental management system through the access portal. For instance, the external access device may be a mobile phone, portable computer, a tablet, a PDA (Personal Digital Assistant) or a dedicated device provided for this sole purpose. The emergency responder may access the information via wireless Internet or other wireless protocols such as Bluetooth or the Wireless Applications Protocol (WAP), which is an open specification that offers a standard method to access Internet based content and services from wireless devices. The responder's ability to obtain information through the access portal depends on preferences and permissions of the resident as well as other information. For instance, the responder may need to provide a name, password, public key certificate, or the like, before being granted access to, and a download of, the information.

For purposes of illustration the access portal will be described in connection with an environmental management system that provides both security and automation features. However, the access portal also may be used with a monitoring system that provides either security or automation functionality.

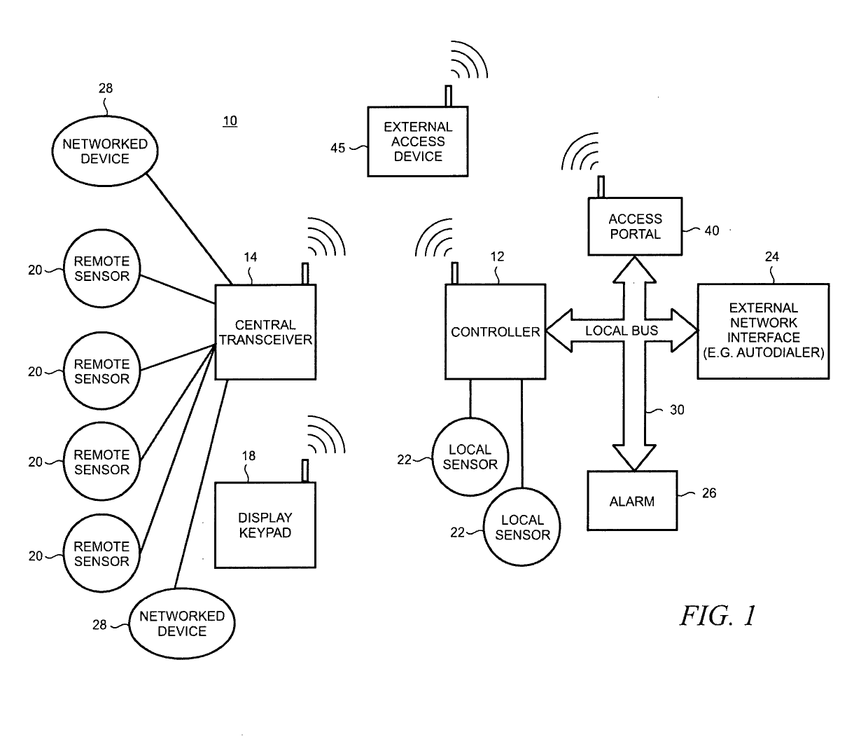

As shown in FIG. 1, the illustrative environmental management system 10 comprises a central control unit 12, a central transceiver 14 (which in some cases may be eliminated and replaced by a receiver incorporated in the central control unit 12), a console display/keypad 18, a plurality of remote sensors 20 and local sensors 22, networked devices 28, an external network interface 24 and an alarm 26. The remote sensors 20 may be wirelessly or hard-wired to the central transceiver 14, which communicates with the central control unit 12 via a wireless protocol. The central control unit 12 also communicates with the console display/keypad 18 over a wireless link. The central control unit 12 is connected to the external network interface 24 (e.g., an autodialer to communicate over the public switched telephone network or a data connection to communicate over the Internet) and the alarm 26 either wirelessly or via a local bus such as local bus 30. The central control unit 12 optionally may also be hardwired to one or more local sensors 22.

Sensors 20 and 22 may be any appropriate device that can monitor and detect a defined condition and, in response to a detected condition, generate a warning. These conditions include, for example, security breaches, fire hazards, carbon monoxide and power failure and electrical power outages. Networked devices 28 may include networked appliances (e.g., refrigerators, ovens, lights, television and stereo units, and media centers) and other automation and control devices and systems such as lighting, heating and air conditioning, window shades or curtains, pool heaters and filtration systems, lawn sprinklers, and ornamental fountains, which provide both monitoring and control capabilities.

Currently available wireless security systems use any of a variety of different physical and data link communication standards. For example, such systems may use, without limitation, IEEE 802.11 (e.g., 802.11a; 802.11b; 802.11 g), IEEE 802.15 (e.g., 802.15.1; 802.15.3, 802.15.4), DECT, PWT, pager, PCS, Wi-Fi, Bluetooth™, cellular, and the like. While the wireless security systems, and hence wireless controllers employed in such systems, may encompass any of these standards, one particularly advantageous network protocol that is currently growing in use is ZigBee™, which is a software layer based on the IEEE standard 802.15.4. Unlike the IEEE 802.11 and Bluetooth standards, ZigBee offers long battery life (measured in months or even years), high reliability, small size, automatic or semi-automatic installation, and low cost. With a relatively low data rate, 802.15.4 compliant devices are expected to be targeted to such cost-sensitive, low data rate markets as industrial sensors, commercial metering, consumer electronics, toys and games, and home automation and security. For these reasons ZigBee may be particularly appropriate for use in both wireless security systems and wireless home automation systems.

Access portal 40 may be implemented as a base station, router, switch, access point, or similar device that can communicate over a LAN or WAN network with external access device 45. Access portal 40 may be an independent unit or it may incorporated with other components of the environmental management system 10 such as the external network interface 24 or the central control unit 12. Various network level protocols may be used over any of the aforementioned physical and data link standards to provide communication among the various components of the environmental system 10. While the IP protocol suite is used in the particular implementations described herein, other standard and/or communication protocols are suitable substitutes. For example, X.25, ARP, RIP, UPnP or other protocols may be appropriate in particular installations. In the IP protocol suite, which operates within the network layer of the International Standard Organization's Open System Interconnect model, packets of data transmitted through a network are marked with addresses that indicate their destination. Established routing algorithms determine an appropriate path through the network such that the packet arrives at the correct device. The packets also contain information that indicates the address of the transmitting device, which the receiving device may use to reply to the transmitting device. Even within the IP protocol suite, a variety of different standard and/or proprietary transport protocols may be employed (e.g., TCP, UDP, RTP, DCCP, TLS, HTTPS, FTPS, SIP, SSH). It should be noted that the protocols and standards used to establish communication among the components within the environmental management system 10 may be but are not necessarily the same as the protocols and standards used to establish communication between the access portal 40 and the external access device 45.

When the system generates an alert that is forwarded to the appropriate party or parties via the external network interface 24, an emergency responder or responders is dispatched to the premises. The responder is equipped with an external access device (e.g., access device 45) that is used to obtain information from the monitoring system via the access portal. An application residing on the external access device allows the responder to communicate through the access portal 40 by providing, for example, a graphical user interface (GUI). For instance, if communication is established between the access device and the access portal over the Internet, the application may be a web browser. Of course, the GUI and other necessary application-level communication structures and functions (e.g., initialization, handshaking) may be provided using general purpose application software or application specific software.

In some cases the responder may not initially have the street address of the premises that have generated the alert. For instance, the alert received by the outside party may simply include an alternative identifier such as an IP address that generated the alert. In other cases the opposite problem may arise. That is, the responder may have the street address, but upon arriving at the premises does not have the IP or other wireless network address necessary to establish communication with the access portal 40. In either case the outside party or the responder may need to access a master database that relates the alternative identifier (e.g., the IP address) to a street address. The database may reside on the responder's external access device or in a central facility that is accessible to the responder through the external device.

In one example, the emergency responder (or the dispatcher who forwards the information to the emergency responder) will only have the physical (e.g., street) address of the premises from which the alert is received. The responder may have access to a database that relates the physical address of the premises to the corresponding URL for the premises. In this case the responder must still obtain the network address (e.g., IP address) for the premises in order to establish communication with the access portal. This may be accomplished, for example, using a Domain Name System (DNS). DNS is a distributed database system that translates URLs to IP addresses and IP addresses to URL's. The information required to perform such translations is stored in DNS tables. Any application program employed by the responder or dispatcher that uses a URL can be a DNS client. DNS is designed to translate and forward queries and responses between clients and servers. Since the IP address of the access portal may change for a variety of reasons, the Dynamic Domain Name Service (DDNS) may be employed to allow the responder to locate the current IP address of the access portal.

Once the responder has arrived at the premises and performed any necessary initialization and handshaking processes that may be necessary to initiate communication with the access portal 40, the responder in some cases may still need to demonstrate that he or she has been authorized by the resident or other occupant to communicate with the environmental management system. In this way the resident can control the dissemination of information and prevent tampering with the environmental management system. For example, as previously noted, access may only be permitted upon entry of an appropriate password by the responder. The appropriate password or other information needed to obtain access may reside in the aforementioned master database, which as previously noted may reside on the responder's external access device or in a central facility available to multiple responders. Alternatively, or in addition thereto, various encryption techniques may be employed to limit access to the information. For instance, a symmetric or asymmetric encryption key arrangement may be employed in which the responder requires a decryption key to access information that is transmitted in an encrypted form by the environmental management system.

Once the responder has obtained access by the appropriate means, the responder may be able to access all the information available to the environmental management system and remotely control all the functionality it offers (e.g., the ability to turn on/off lights, power, etc.). Alternatively, different levels of access may be offered to different responders. Moreover, the access that is provided to any individual responder may depend on the nature of the alert that the environmental management system generates. In general, the emergency responder may be any public or private organization, agency, business, institute or the like. For instance, if the alert is indicative of a fire, appropriate fire-fighting personnel (public or private), as well as police or other public or private security firms may be granted complete access. On the other hand, if the alert is indicative of, say, a plumbing failure that is causing flooding, a responder associated with the resident's plumbing service may be provided access. In this case the responder may even be a neighbor who is given access by the resident under such circumstances since the neighbor, in this example, may be able to enter the premises and turn off the main water supply. While in many or most of these situations the service provider who supports and services the environmental management system may generally also be granted access to the information though the access portal in addition to any dedicated-function responders who are granted access, this need not always be the case.

In some cases the emergency responder may be issued an authorization certificate that demonstrates that proper authorization has been provided to this particular responder. The authorization certificate may be issued by any private or public organization such as a service provider responsible for the environmental management system, the manufacturer or system integrator of the environmental management system, or, possibly in the case of officials such as the police or fire departments, a public authority. One advantage arising from the use of an authorization certificate is that the end-user (e.g., the resident or occupant of the premises) does not need to have a direct pre-established relationship (e.g., a contractual relationship) with the emergency responder or the organization that employs the emergency responder.

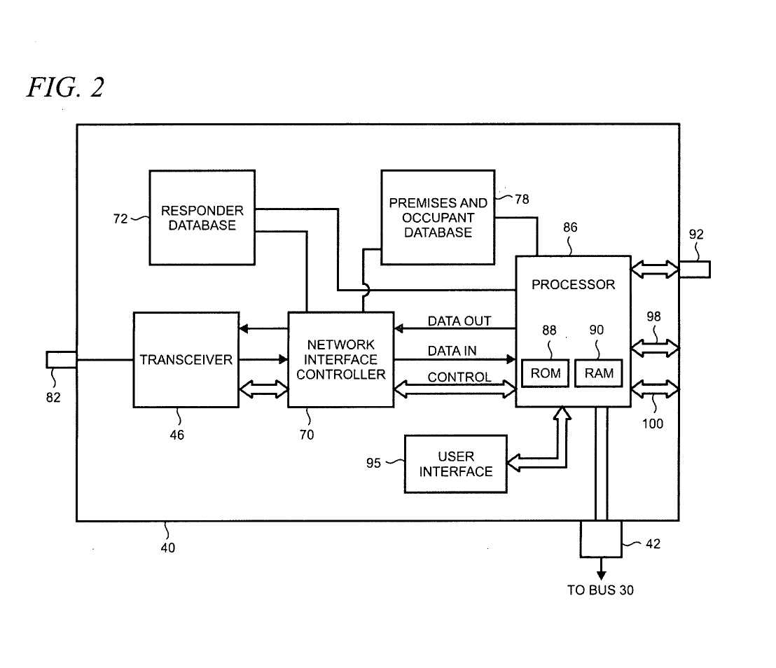

As shown in more detail in FIG. 2, the access portal 40 includes a bus interface 42, processor 86 having ROM 88 and RAM 90, and programming port 92, front-end transceiver 46, network interface controller 70 and antenna port 82. The bus interface 42 is provided to communicate with the bus 30 from the controller 12. If the bus 30 is a twisted pair conductor, bus interface 42 may be simply a pair of contacts for receiving the twisted pair. The bus interface 42 forwards the signals received from the controller 12 to the processor 86. Depending on the capabilities of the wired network, the bus interface 42 may be configured for one way or bidirectional communication. The configuration of front-end transceiver 46 will depend on the particular physical and data link communication standards that the external access device uses to communicate with the access portal 40. For instance, if the wireless standard is ZigBee compliant, front end transceiver 46 may be a ZigBee transceiver of the type that is widely available from a number of manufacturers, including Motorola. Network interface controller 70 may include the functionality of a switch or router and also serves as an interface that supports the various communication protocols, e.g., IP, that are used to transmit the data over the wireless network. The access portal 40 may also include RAM port 98 and ROM port 100 for, among other things, downloading various network configuration parameters, distribution lists (discussed below), and upgrading software residing in the processor 86. User interface 95 (e.g., a keypad/display unit) allows control of the various user-adjustable parameters of the access portal 40.

Access portal 40 also includes an emergency responder database 72 that is used to store information pertaining to each authorized responder. In the simplest case the database includes the password or other access information that is needed to confirm that a responder is entitled to access. The password or other access information is compared to the access information provided by the responder using the external access device 45 when communication is first established with the portal 40. If, on the other hand, different levels of access are to be provided based on the nature of the emergency and/or the particular responder, the database 72 will need to maintain additional information. If, as previously mentioned, one or more authorized responders have been issued authorization certificates, that information (or information derived therefrom that is used for authorization) may also be contained in the responder database 72.

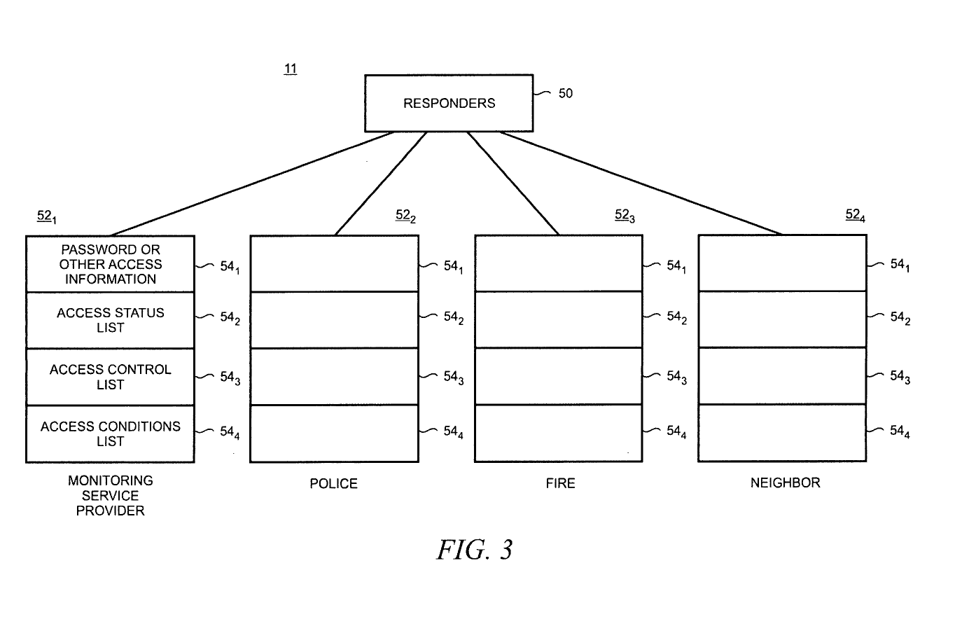

FIG. 3 shows an illustrative representation of an emergency responder database 72 for use when there may be multiple responders and multiple response tiers in which access is to be provided. The representation indicates how the information may be logically structured and linked together. The database 72 is composed of plural records. While the information database 11 is shown having a tree structure, any other appropriate arrangement may be employed to link together the data stored in information database 11. The database includes a folder of authorized responders 50, each of whom in turn have their own folder. For instance, in the example of FIG. 3, the responder folders 52₁-52₄ include a folder for a private service provider (folder 52₁), a local police department (folder 52₂), a local fire department (folder 52₃), and a designated neighbor (folder 52₄). Each of the responder folders 52 is linked to a series of records 54 in which the information associated with each responder is stored. For example, in FIG. 3, illustrative responder records include a list for a password or other authentication credentials (such as those derived from an authorization certificate) 54₁, an access status list (for establishing a level of allowed access to status information) 54₂, an access control list (for establishing a level of allowed access to control functionality) 54₃, and an access conditions list (for establishing conditions under which access to either status information or control functionality is allowed) 54₄.

Access portal 40 may also include a premises and occupants database 78 that contains pertinent information about the premises and/or the occupant and any other residents of the premises. This database may include characteristic information that defines the premises and/or occupant(s) and which could be useful to an emergency responder arriving at the premises. For example, the premises database may include a map of the premises, possibly showing access conditions, the location of major items in each room or zone, the location of any flammable materials, and the composition of various construction materials (additional maps, such as shown below, may show the location of cameras, sensors and the like). Information that may be included about the occupants may include their name, age, heath problems, medications or other information concerning the occupants that could prove useful during an emergency.

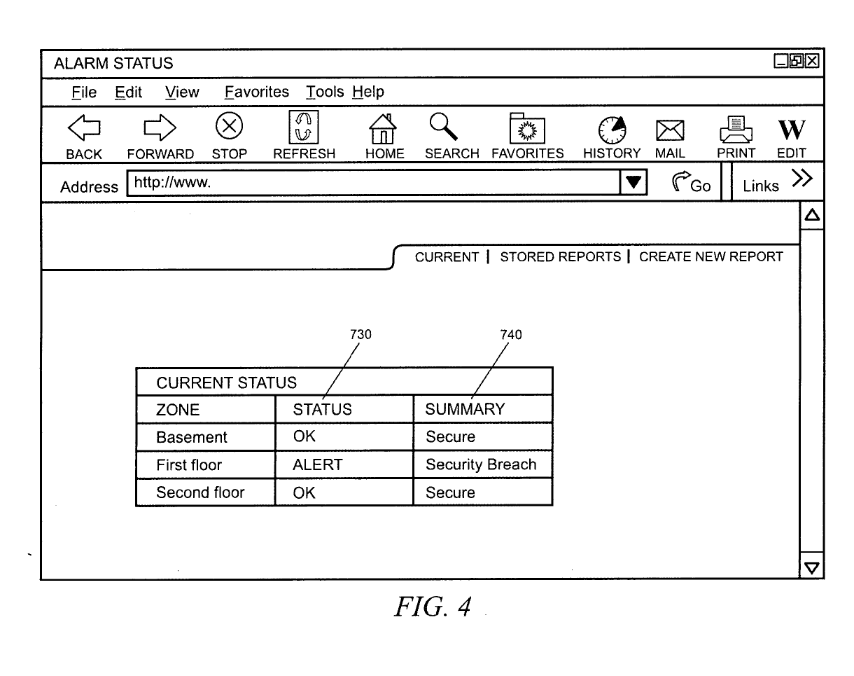

FIG. 4 shows an example of the main status menu that an authorized responder may view on external access device 45 upon establishing communication with the access portal 40. The menu shows a current status report that allows the responder to view current security information. In general the access portal 40 will obtain the security information directly from the controller 12. However, the access portal 40 may have dedicated or specialized databases (e.g., premises and occupants database 78) that supplement the information obtained from the controller 12. For each identified zone or group of zones within the premises, current status information may be displayed. Current status information may include whether an alarm situation has been identified. For example, words, phrases, symbols, and/or other identifiers may be used to warn the responder of an alarm situation or other alarm worthy events. For example, icons or other images may indicate status information, such as alarm, door or window open, tampering, AC power failure, door or window shut, sensor bypassed, battery low, elevated CO levels, and other status data for each sensor or group of sensors. Different identifiers may be used to indicate varying degrees of severity. Summary information may be provided for situations that may be identified as alarm worthy events. This information may be customized by the resident or other occupant of the premises. In some cases a technician may be required to customize the information, which may be performed at the time of installation or at a later date. Further detailed information may be viewed for identified alarm situations. Detailed information may include video footage, photographs and other data.

Depending on the medium of communication and the particular access device employed, the responder may navigate through possible choices in the menu via voice, keypad, touchpad, number selection and other selection methods. For example, when an alert situation is detected, the status column 730 may indicate such an event to the user. In the example of FIG. 4, the term “ALERT” may be displayed. By selecting the alert notification entry in column 730, the responder may receive details regarding the alert. Details regarding the alert notification may also be displayed in summary column 740. For example, the responder may be informed that there was a security breach on the first floor of the premises. In some cases the responder may also have the option to view photographs and/or video clips at the time of the alarm incident.

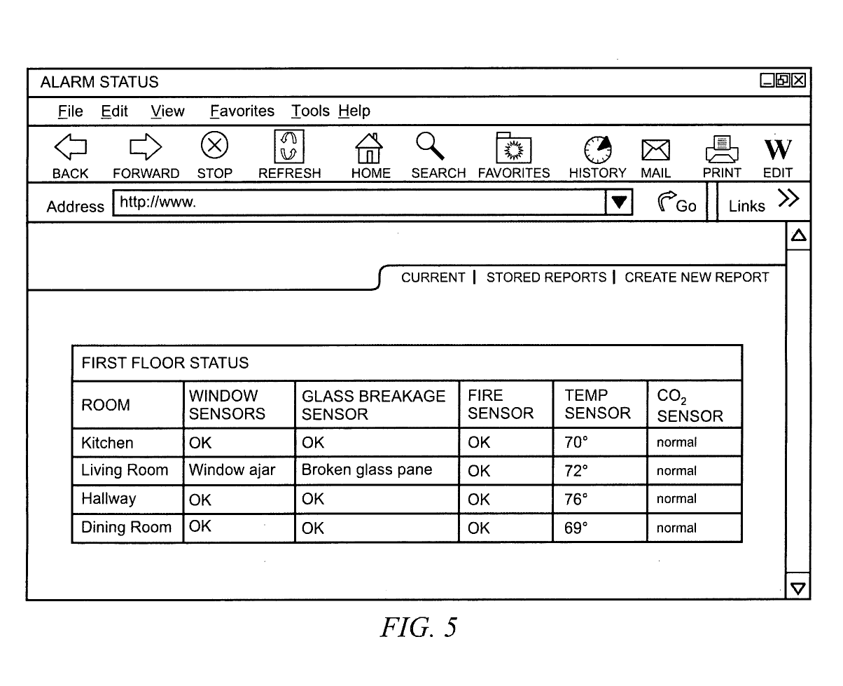

Other events may also be reported and tracked such as the opening of the kitchen door or garage door, for example. Details and other data may be provided, such as the date and time of the occurrence. Thus, a detailed log of events detected by security and other sensors may be reported and tracked at varying levels of detail. For example, by selecting the first floor zone in FIG. 4 the responder is directed to another menu (FIG. 5) showing the status of each sensor in each room of the first floor. Depending on the nature of the sensor, the status may be expressed in terms of a value (e.g., temperature), an event (tripped, fire, malfunction, tamper, disarmed) or in any other appropriate terms. By selecting an individual sensor in FIG. 5 additional information may be displayed. For example, by clicking on the CO sensor for a particular room, a graphical display may be presented showing variations in the CO level in that room over some predefined period of time.

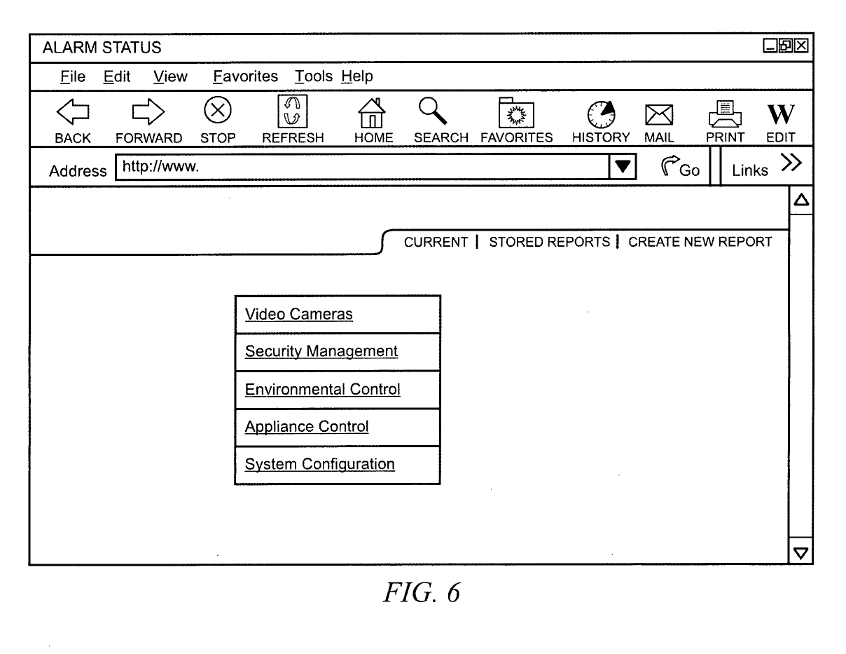

FIG. 6 shows an example of the main control menu through which the responder may control the functions of the environmental management system. The control menu screen displays one or more functions that may be called from the main menu. Such functions include control of the video camera, security management functions, environmental control (such as control of the HVAC system throughout the premises), control of various appliances or media equipment and system configuration functions. When the external access device 45 is operating to control the functionality of various components in the environmental management system, it is effectively serving as a proxy for the user interface associated with the controller 12. As previously mentioned, the access device 45 may provide the responder with all or a limited subset of functions available directly through the controller, possibly depending on the nature of the alert and/or the particular responder.

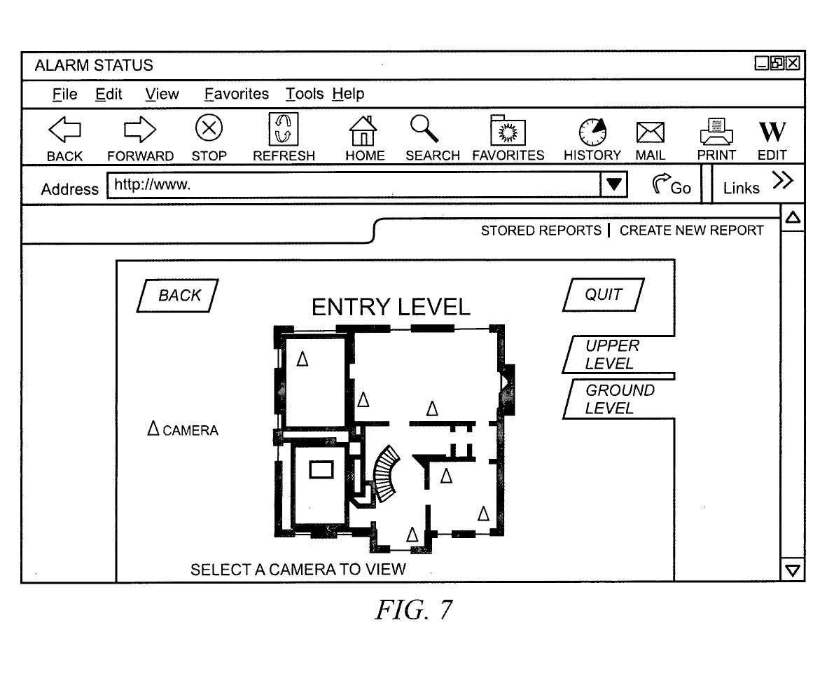

FIG. 7 shows a sub-menu that appears on the display of the external access device when the video camera function is selected. The sub-menu displays a floor plan of the premises showing the location of various video cameras distributed throughout the premises. By selecting a particular zone or room in the floor-plan additional sub-menus appear that allow the responder to select any of the cameras in the selected zone or room. Selection of a particular camera displays the current being scene being imaged by that camera. The responder is also presented with various control functions to control the operation of the camera such as its orientation (e.g., pan and tilt), thereby allowing the responder to view any portion of the room or zone observable by the camera. In addition to viewing the current scene, the responder may also be presented with a function allowing previously recorded images from the camera to be viewed so that the responder can view the scene, e.g., ten minutes earlier, perhaps when an intruder was in the view of the camera. Other functions offered through the control menu in FIG. 6 may operate in a similar manner.

As mentioned at the outset, in some cases it may be preferable if the information and control functionality provided by the access portal 40 were available from an off-premises location. This may be advantageous for a number of reasons. For instance, if the information were available from an off-site remote hosting server, for example, then access to the information will not be prevented in the event that there is a power outage or other failure on the premises. Also, the use of a remote hosting server allows information and control functionality to be centralized for multiple premises, thereby potentially simplifying the process of accessing the information for the responder and reducing administrative and other overhead costs. In effect, the remote host server caches the information from the different environmental management systems.

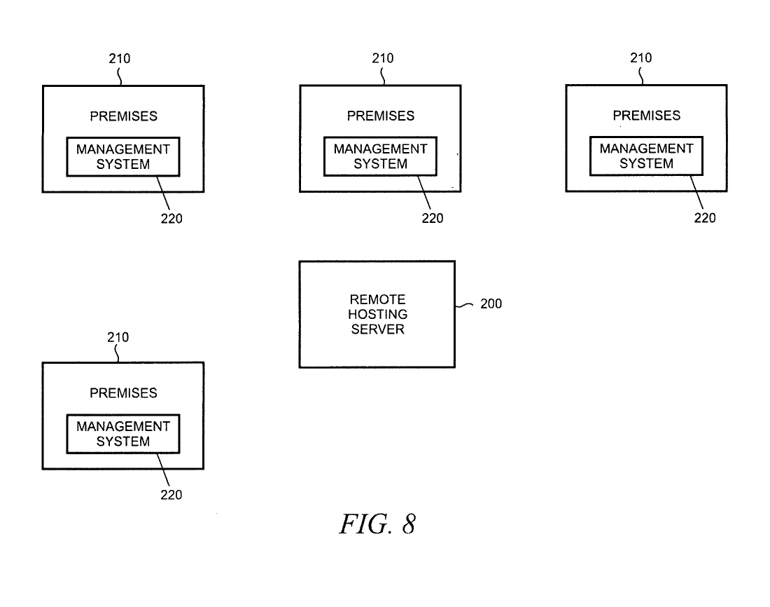

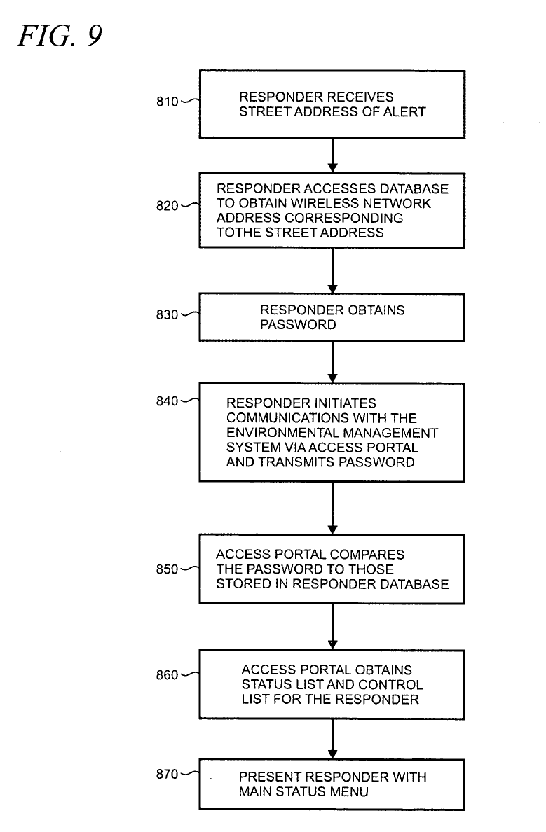

FIG. 8 shows a remote hosting server 200 that is in communication with multiple environmental management systems 220 located on multiple premises 210. The environmental management systems 220 may be of the type generally depicted in FIG. 1. The remote hosting server 200 may largely include the same functional elements as the access portal 40 such as shown in FIG. 2, except with larger capacity to handle and otherwise process multiple premises simultaneously.

Communication between the remote hosting server 200 and each of the individual environmental management systems 220 may be established via the external network interface 24 associated with the systems. As previously mentioned, in some examples the external network interface 24 may be a data connection to communicate over the Internet in either a wired or wireless manner. The data connection should provide a high level of security to ensure that it is only available to authorized responders and other users.

The appropriate level of security necessary for the data connection between the external network interface 24 and the remote hosting server 200 may be achieved in any of a number of ways. For example, if the Internet is employed as the transport medium, a virtual private network (VPN) may be established between the remote hosting server 200 and the external network interface 24 of the various environmental management systems 220. A VPN is a wide area network that connects private subscribers together using the public Internet while ensuring that their traffic is not readable by the Internet at large. All of the data is encrypted to prevent others from reading it, and authentication measures ensure that only messages from authorized VPN users can be received. A VPN may be implemented using any of a number of protocols that are sometimes referred to as tunneling protocols. One such tunneling protocol that may be employed to implement a VPN is the Internet Protocol Security (IPsec). Other examples of tunneling protocols that may be employed include the L2TP and PPTP tunneling protocols.

It should be noted that the information may be communicated to the remote host server 200 in either a push or pull manner. In a typical client/server environment involving a pull, the client engages a server with a request for service or information. The server responds to the request and returns information to the client. This interaction is referred to as a pull, since the customer is effectively pulling information from the server. An example of a typical pull is searching a search engine on the Internet. In this example, the client transmits a search string to the server, which responds with a list of matching elements. In the present case, the remote host server (acting as the client in this case) requests that the information be forwarded to it by the access portal (acting as the server in this case).

In a push interaction, the server transmits information to the client without explicit instruction from the client to do so. This interaction is referred to as a push, since the server is effectively pushing information to the client. A good example of a typical push is the frequent transmission of a weather forecast, news headline, or stock quote. The server runs software that is configured to record the weather forecast, news headlines, or stock quote at predetermined intervals and automatically transmit updates to the client. Accordingly, even though the client is not requesting the information at these intervals, the information is transmitted from the server. In the present case, the information from the access portal may be automatically transmitted to the remote host server 200 using a push interaction.

In either a push or pull interaction, the updated information may be forwarded from the access portal to the remote host server 200 at regular intervals (e.g., hourly, daily, etc). In addition, or as an alternative thereto, the information may be forwarded using a push interaction whenever a significant event is detected by the environmental management system. For example, if a security sensor is activated or if there is a system failure on the premises, the information may be pushed to the remote host server at that time. Information related to the premises, such as the information stored in the premises and occupants database 78, which is generally static information that does not change over time, may be forwarded to the remote host server once and only updated in the event of any changes.

FIG. 9 is a flowchart showing an example of how a responder establishes communication with an environmental management system after an alert has been generated. In this example, the information is obtained by the responder directly from the access portal located on the premises and thus no remote host server is employed. The process begins in step 810 when the responder receives a street address from which an alert has been received. The responder will generally be notified of the alert and provided with the street address from a central facility. The alert, along with the appropriate street address, may be received on the responder's external access device. In step 820 the responder accesses a database on the external access device to obtain a wireless network address that corresponds to the street address. Step 820 may be performed before or after the responder arrives at the premises. The database may be located in the external access device itself or in a server at some other site (e.g., the central facility) that the responder can access using the external access device. At the same time (or at some other time), in step 830, the responder obtains the appropriate password or other identifier needed to obtain status information from the environmental management system located on the premises. Once again, the password may be located in the external access device itself or in a server at some other site (e.g., the central facility) that the responder can access using the external access device. Steps 820 and 830 may be performed before or after the responder arrives at the premises. Next, in step 840 the responder initiates communication with the environmental management system via the access portal and in step 840 receives a request from the access portal to enter a password. The access portal in turn (step 850) compares the password it has received from the responder to the password stored in its responder database. Once it has identified the appropriate responder folder (e.g., responder folders 52 in FIG. 3) in the database in step 860, the access portal obtains the access status list and the control list (e.g., folders 54₂ and 54₃ in FIG. 3) for that particular responder so that it can determine the correct level of access to provide. The responder is then presented with a main status menu such as depicted in FIG. 4, which the responder may use in step 870 to obtain status information as discussed above in connection with FIGS. 4 and 5. The main status menu will only allow the responder to access information that is allowed in accordance with the access status list for that particular responder. Likewise, if the responder selects the main control menu he or she will only be given control of the environmental management system to the extent allowed by the control status list located in the responder database of the access portal.

The processes described above in connection with the environmental management system and the external access device may be implemented in general, multi-purpose or single purpose processors. Such a processor will execute instructions, either at the assembly, compiled or machine-level, to perform that process. Those instructions can be written by one of ordinary skill in the art following the description presented above and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized wireline or wireless transmission signals.

1. At least one computer-readable medium encoded with instructions which, when executed by a processor, performs a method including:
receiving a wireless request from a responder through an external access device to obtain at least status information available to an environmental management system employed in a premises;
authorizing the responder through the external access device to communicate with the environmental management system; and
in response to a request received from the external access device, wirelessly transmitting to the external access device requested status information obtained from at least one sensor in the environmental management system.

2. The computer-readable medium of claim 1 wherein authorizing the external access device comprises receiving a password from the external access device and comparing the password to a list of authorized responders.

3. The computer-readable medium of claim 1 wherein authorizing the external access device comprises confirming that the responder is authorized by an authorizing certificate.

4. The computer-readable medium of claim 1 wherein authorizing the external access device comprises encrypting the requested status information in a format that can be decrypted by responders authorized to receive the requested status information.

5. The computer-readable medium of claim 1 wherein, prior to receiving the wireless request, further comprising communicating an alert reflecting a condition on the premises that deviates from a norm.

6. The computer-readable medium of claim 1 further comprising receiving the status information from an external network interface of the environmental management system.

7. The computer-readable medium of claim 6 wherein the status information is received in a push arrangement.

8. The computer-readable medium of claim 6 wherein the status information is received in a pull arrangement.

9. The computer-readable medium of claim 6 wherein the status information is received using a tunneling protocol.

10. The computer-readable medium of claim 1 wherein the wireless request further comprises a request to obtain information specifying one or more defining characteristics of the premises and/or at least one occupant residing in the premises and further comprising accessing a database of information containing the one more defining characteristics of the premises and/or at least one occupant residing in the premises and wirelessly transmitting information obtained from the database to the external access device.

11. The computer-readable medium of claim 1 further comprising wirelessly transmitting a status menu to the external access device providing user selectable options and wherein the requested status information that is transmitted to the external access device conforms to selected ones of the options.

12. The computer-readable medium of claim 10 further comprising wirelessly transmitting a control menu to the external access device providing user selectable control options over the environmental management system.

13. At least one computer-readable medium encoded with instructions which, when executed by a processor, performs a method including:
receiving a physical address associated with a premises from which an alert has been received;
obtaining a wireless address of an access portal associated with an environmental management system that is located on the premises and which generated the alert;
obtaining an authorization credential associated with the premises that provides access to at least select status information acquired by the environmental management system;
forwarding the password to the access portal in a wireless manner; and
in response to a request for at least a portion of the select status information, receiving the portion of the select status information from the access portal in a wireless manner.

14. The computer-readable medium of claim 13 wherein the access portal is located on the premises.

15. The computer-readable medium of claim 13 wherein the access portal is a remote hosting server located off-premises.

16. The computer-readable medium of claim 15 wherein the remote hosting server is associated with a plurality of environmental management systems.

17. The computer-readable medium of claim 13 wherein the request further comprises a request to obtain information specifying one or more defining characteristics of the premises and/or at least one occupant residing in the premises and further comprising wirelessly receiving the information containing the one more defining characteristics of the premises and/or at least one occupant residing in the premises.

18. The computer-readable medium of claim 14 further comprising wirelessly receiving a status menu providing user selectable options and wherein the requested status information that is received conforms to selected ones of the options.

19. The computer-readable medium of claim 20 further comprising wirelessly receiving a control menu providing user selectable control options over the environmental management system.

20. The computer-readable medium of claim 19 further comprising selecting at least one control option to control at least one function performed by the environmental management system.

21. An access portal for facilitating a transfer of information from an environmental management system used on a premises to an authorized responder equipped with an external access device, comprising:
a first electronic memory segment configured to store access information associated with at least one authorized responder;
a second electronic memory segment configured to store information pertaining to the premises and/or at least one occupant residing in the premises;
a processor for identifying a responder as an authorized responder by comparing identifying information received from the responder through the external access device with the access information stored in the first electronic memory segment; and
a wireless transceiver for (i) receiving the identifying information and requests from the responder and, (ii) in response to a request, transmitting the premises information stored in the second electronic memory segment and status information obtained from at least one sensor in the environmental management system to an authorized responder.

22. The access portal of claim 21 wherein the identifying information received from the responder is a password or other authorizing credential.

23. The access portal of claim 21 wherein the wireless transmitter is configured to transmit a status menu to the external access device providing user selectable options and wherein the requested status information that is transmitted to the external access device conforms to selected ones of the options.

24. The access portal of claim 21 wherein the wireless transmitter is configured to transmit a control menu to the external access device providing user selectable control options to provide wireless control to selected ones of the options.

25. The access portal of claim 21 wherein the access information stored in the first electronic memory segment includes information specifying different levels of access for different authorized responders.

26. The access portal of claim 21 wherein the premises information and status information is transmitted in an encrypted format.
